(19) United States
(12) Patent Application Publication
(10) Pub. No.: US 2006/0003149 A1
(43) Pub. Date: Jan. 5, 2006

(54) Compound print layer quickly and neatly transcribed on a substratum

(76) Inventor: Ching Ming-Chung, Kaohsiung City (TW)

Correspondence Address: TROXELL LAW OFFICE PLLC, SUITE 1404, 5205 LEESBURG PIKE, FALLS CHURCH, VA, 22041, US

(21) Appl. No.: 10/880,545

(22) Filed: Jul. 1, 2004

(51) Int. Cl. B32B 3/00

(52) U.S. Cl. 428/195.1

(57) ABSTRACT

A compound print layer quickly and neatly transcribed on a substratum includes a removable PET film base layer, a protective TPU layer adhered on the PET film base layer, a resin layer adhered on the TPU layer, and a printed layer formed with a colored design or pattern with ink sprayed by an inkjet printer managed by a computer. Then the compound print layer is transcribed with heat on the substratum, and then the PET film base layer is peeled off to be come the compound print layer in the invention, provided with wear-enduring characteristic.

### BACKGROUND OF THE INVENTION

1. Field of the Invention

This invention relates to a compound print layer quickly and neatly transcribed on a substratum, particularly to one possible to be transcribed on a substratum with only one operation and completely adhered, wear-enduring and substantially pretty.

2. Description of the Prior Art

As shown in FIGS. 1 and 2, a conventional print layer is directly printed on a substratum 10a made of leather or the like, having several designs 11a formed on various nets and to be printed on the substratum one by one, owing to color difference to be printed for several times to form a design of plural layers, and then a protective layer 12a coated on the substratum 10a printed with the design 11a for preventing the colored design or pattern from peeling off.

However, the conventional print layer constituted with the design 11a on the substratum 10a cannot be formed pretty enough, and further, more than one net should be used for forming a design 11a thereon. But the nets are not easy to be carried around, and printing work has to be operated manually, generally needing 3 to 6 days' for completing the work, resulting in tardiness in finishing the work and waste in time and work.

### SUMMARY OF THE INVENTION

The objective of the invention is to offer a compound print layer quickly and transcribed with heat on a substratum, keeping fresh the colored design or pattern the substratum, and having the effects of wear-enduring and no peeling off.

The feature of the invention is a compound print layer consisting of a removable PET film base layer, a protective TPU layer, a resin layer and a printed layer. The printed layer is printed on the resin layer with a colored design or pattern with ink sprayed by an inkjet printer managed by a computer, and then the compound print layer is transcribed with heat on the substratum. After that, the PET film base layer is peeled off the resin layer and discarded, with the protective TPU layer exposing out to keep the printed layer intact.

### BRIEF DESCRIPTION OF DRAWINGS

This invention will be better understood by referring to the accompanying drawings, wherein:

FIG. 1 is a block diagram of steps used in a conventional method for a print layer;

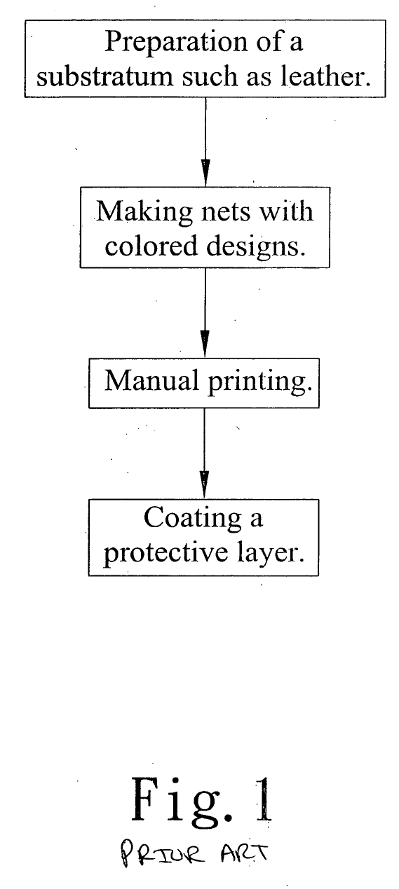

FIG. 2 is a cross-sectional view of the print layer made by the conventional method;

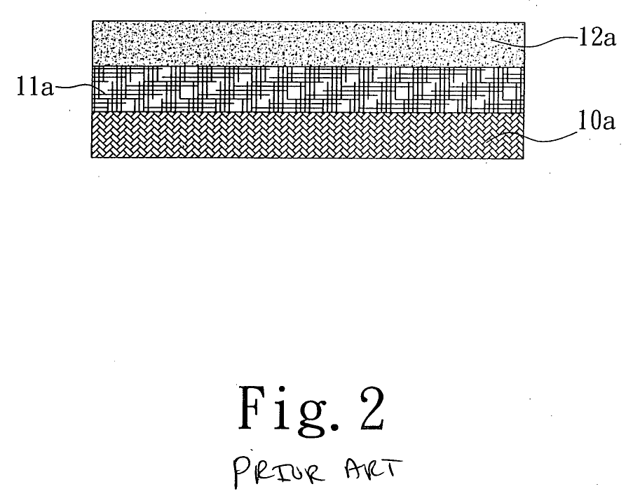

FIG. 3 is a cross-sectional view of a compound print layer in the present invention;

FIG. 4 is a block diagram of steps used for forming the compound print layer in the present invention.

FIG. 5 is a cross-sectional view of the compound print layer being adhered on a substratum in the present invention; and,

FIG. 6 is a perspective view of the compound print layer transcribed on the substratum in the present invention.

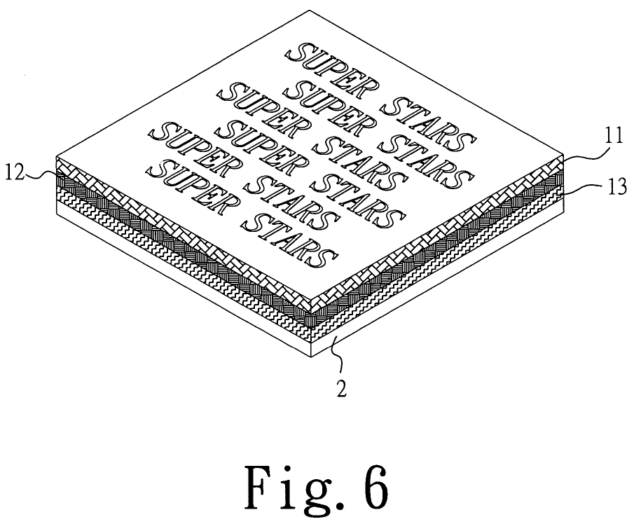

### DETAILED DESCRIPTION OF THE PREFERRED EMBODIMENT

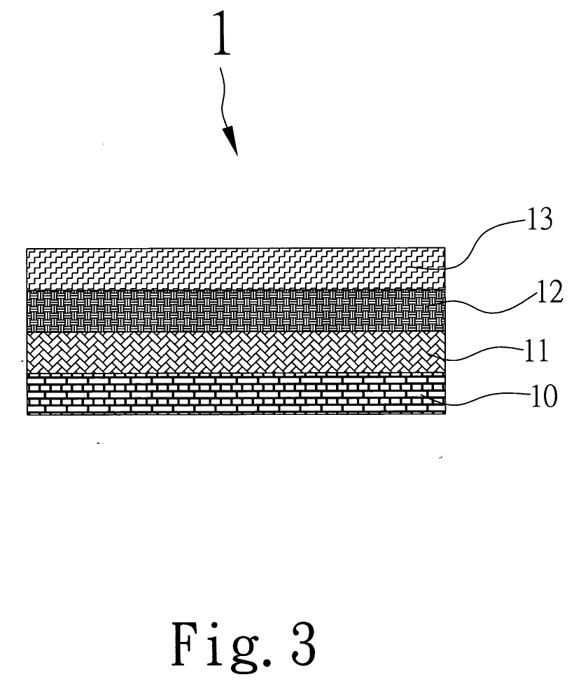

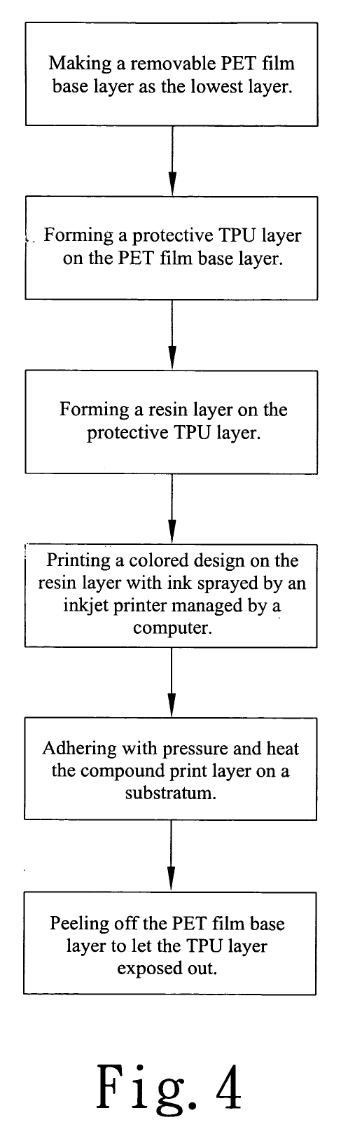

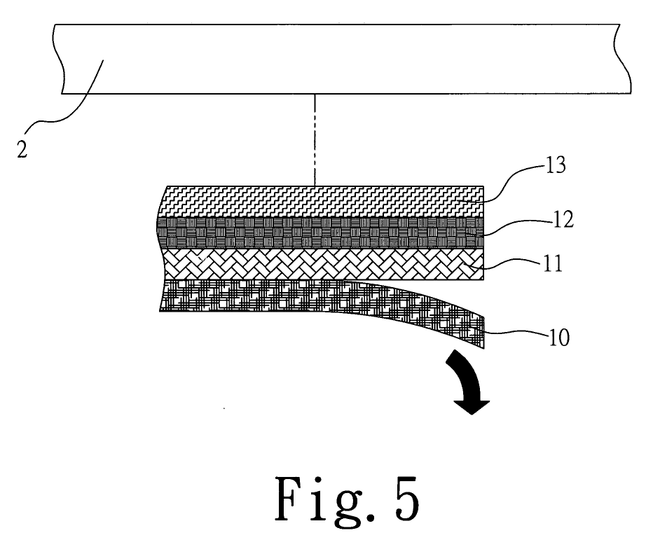

A preferred embodiment of a compound print layer 1 quickly and neatly transcribed on a substratum in the present invention, as shown in FIGS. 3, 4 and 5, is to be transcribed with heat on a substratum 2, including a removable PET (polyethylene terephthalate) film base layer 10, a protective TPU (thermoplastic polyurethane) layer 11, a resin layer 12 and a printed layer.

The PET film base layer 10 is the lowest in the compound print layer 1, removable from the TPU layer after the compound print layer is transcribed with heat on the substratum 2.

The protective TPU layer 11 is adhered on the PET film base layer 10, becoming an outer layer after the PET film base layer 10 is peeled off.

The resin layer 12 is coated on the protective TPU layer, capable to be melted with heat. The printed layer 13 is formed on the resin layer 12, having a colored design or pattern printed by ink sprayed by an inkjet printer managed by a computer. Then the compound print layer as a whole is transcribed with heat on the substratum 2, and finally the PET film base layer 10 is peeled off and discarded.

As the protective TPU layer 11 is thermoplastic, it can be adhered on the PET film base layer 10 by heating, and then the resin layer 12 can be coated on the TPU layer 11, which also has an effect of heat transcription.

The printed layer 13 can be formed on the resin layer, by printing a colored design or pattern with ink sprayed by an inkjet printer managed by a computer, by dint of absorbing capacity of the resin layer 12. The ink sprayed on the resin layer 12 is hard to fade in its color, or peel off. Thus compound print layer 1 is formed complete by the aforesaid description, and then can be transcribed with heat on the substratum 2, with the temperature controlled at 120° C. or so with only one-time operation. The substratum 2 can be leather, woven material, plastic or PU, etc.

The compound print layer quickly and neatly transcribed on a substratum according to the invention has the following advantages,

1. It can be completed only one-time operation of ink printing: a colored design or pattern is directly printed on the resin layer by means of a inkj et printer controlled by a computer, avoiding several times of net printing operation used in the conventional print layer described above, which requires much time and work.

2. It can be upgraded in its efficiency in forming: the colored design or pattern formed with ink sprayed by a inkj et printer managed by a computer can be transcribed with heat on a substratum, upgrading the efficiency of the printing operation,

3. It has a wear-enduring characteristic: the protective TPU layer is exposed after the PET film base layer is peeled off to enable the resin layer and the printed layer protected from wearing because of the wear-enduring property of the TPU layer.

4. It has the best adhesiveness: the TPU layer and the resin layer are both thermoplastic, so every layer of the compound print layer has the best adhesiveness, in addition to the ink absorbing function of the resin layer which can keep the ink from dropping off, always maintaining the pretty and neat printed layer intact.

While the preferred embodiment of the invention has been described above, it will be recognized and understood that various modifications may be made therein and the appended claims are intended to cover all such modifications that may fall within the spirit and scope of the invention.

1-7. (canceled)

8. A compound print system comprising:
a) a substratum; and
b) a compound print layer transcribed on the substratum and having:
i) a removable polyethylene terephthalate film base layer;
ii) a protective thermoplastic polyurethane layer formed directly on the removable polyethylene terephthalate film base layer;
iii) a resin layer formed directly on the protective thermoplastic polyurethane; and
iv) a print layer printed directly on the resin layer, the resin layer adhering the print layer directly to the substratum,
wherein the removable polyethylene terephthalate film base layer is selectively removed from the protective thermoplastic polyurethane layer making the protective thermoplastic polyurethane layer an outermost layer.

9. The compound print system according to claim 8, wherein the substratum is made of leather.

10. The compound print system according to claim 8, wherein the substratum is made of a woven material.

11. The compound print system according to claim 8, wherein the substratum is made of plastic.

12. The compound print system according to claim 8, wherein the substratum is made of polyurethane.

13. The compound print system according to claim 8, wherein the resin layer is adhered to the substratum at a temperature of 120° C.

14. The compound print system according to claim 8, wherein the protective thermoplastic polyurethane layer is made of polyurethane.
